(19) United States
(12) Patent Application Publication
(10) Pub. No.: US 2021/0162479 A1
(43) Pub. Date: Jun. 3, 2021

(54) LINE-SHAPE SPOT LASER BENDING METHOD FOR METAL SHEETS

(71) Applicant: DALIAN UNIVERSITY OF TECHNOLOGY, Dalian, Liaoning (CN)

(72) Inventors: Xuyue WANG, Dalian, Liaoning (CN); Chenghang LI, Dalian, Liaoning (CN); Ying YAN, Dalian, Liaoning (CN); Zihui LI, Dalian, Liaoning (CN); Dongming GUO, Dalian, Liaoning (CN)

(21) Appl. No.: 17/055,939

(22) PCT Filed: Jun. 17, 2020
(86) PCT No.: PCT/CN2020/096562

§ 371 Date: Nov. 16, 2020

(30) Foreign Application Priority Data
Jul. 23, 2019 (CN) 201910664048.5

(51) Int. Cl. B21D 5/00; B21D 11/20

(52) U.S. Cl. CPC B21D 5/008; B21D 11/203

(57) ABSTRACT

The present invention belongs to the technical field of high-efficiency, high-precision and high-performance laser bending of metal sheets, and relates to a line-shape spot laser bending method for metal sheets. The present invention uses a multimode laser scanning mirror or a single piezoelectric deformable mirror to convert laser Gaussian distributed point spots to uniformly distributed line-shape spot, and meanwhile, loads the spots in a bending line area and bends metal sheets so that the temperature field in the bending line of the metal sheet is distributed uniformly to achieve the purposes of reducing warpage deformation, enhancing bending angle consistency and increasing the bending efficiency.

### TECHNICAL FIELD

The present invention belongs to the technical field of high-efficiency, high-precision and high-performance laser bending of metal sheets, and relates to a line-shape spot laser bending method for metal sheets, which is a laser bending method for simultaneous heating through line-shape spots in the bending line of the metal sheet.

### BACKGROUND

Laser bending is a flexible, dieless, force-free and non-contact rapid forming technology, which is easy to realize automatic processing. The existing metal sheet laser bending technology, i.e., the linear scanning sequential heating bending technology, generally uses a point spot moving heat source. The free end of a sheet produces warpage deformation due to the heat accumulation of the moving heat source and the influence of the sheet boundary conditions. In some occasions with high requirements for precision, the deformation may cause bigger quality problems. The current research suggests that the warpage phenomenon is caused by two main reasons: one is the non-uniformly distributed temperature field along the scanning line generated by the laser energy input of the point spot moving heat source; and the other is different geometric constraints on different points in the scanning line of the sheet. A method for enhancing the bending angle consistency of sheets by improving the uniformity of the temperature field in the bending line and reducing the warpage is urgently needed.

The literature “Shen Hong. Research on Precision Control of Laser Bending [D]. Shanghai: Shanghai Jiao Tong University, 2007.”, starting from the temperature field generated by laser scanning, analyzes that under the temperature gradient forming mechanism, warpage deformation is caused by two main reasons: one is that during the mobile scanning process of the laser point heat source, the temperature is basically maintained at 900° C. due to thermal diffusion after rising at the beginning of scanning, the thermal diffusion drops sharply at the end point, heat accumulation causes the temperature to be higher than that at the starting point, and this non-uniform heat distribution leads to warpage deformation; and the other is the geometric constraints of the sheet. The literature introduces a method for reducing the warpage phenomenon, which adopts the combination of uniform acceleration and uniform deceleration for finite element simulation, but it is difficult to realize uniform acceleration and uniform deceleration processing under realistic conditions.

The patent “an energy regulation method for reducing warpage of metal sheets in laser bending” adopts the strategy of combining three-stage variable speed and energy compensation, uses low speed at a section with a small bending angle and high speed at a section with a larger bending angle, and performs energy compensation regulation to correct warpage deformation. However, the method has the disadvantages of complex processing technology, time consumption and low efficiency.

The method for reducing warpage deformation in the above literature needs to be improved. First, the process is complex and difficult to realize in practical applications; and second, the forming efficiency is low, and the cost is high. The existing laser processing equipment mainly adopts a point spot moving heat source loading method, and the current domestic and foreign research and application status is basically that experiments are conducted under the existing equipment conditions to obtain research results and rules.

### SUMMARY

In view of the problem of warpage deformation caused by non-uniform distribution of the temperature field in the bending line of a metal sheet during the laser linear scanning bending process of a point spot moving heat source, the present invention uses a multimode laser scanning mirror or a single piezoelectric deformable mirror to convert laser Gaussian distributed point spots to uniformly distributed line-shape spots, and meanwhile, loads the spots in the bending line area and bends metal sheets so that the temperature field in the bending line of the metal sheet is distributed uniformly to achieve the purposes of reducing warpage deformation, enhancing bending angle consistency and increasing the bending efficiency.

The technical solution of the present invention is as follows:

A line-shape spot laser bending method for metal sheets, comprises the following specific steps:

Step 1: workpiece preparation: according to the dimension and technical requirements, processing metal sheets with the required specifications, including a rectangular sheet 2 and a sector sheet 10, wherein the width of the rectangular sheet 2 is W, and the exradius of the sector sheet 10 is R;

Step 2: line-shape spot setting: for the linear bending of the rectangular sheet 2, installing a multimode laser scanning mirror 6 under the laser head 4 of a laser so as to convert laser Gaussian distributed point spots 5 emitted by the laser head 4 of the laser to uniformly distributed line-shape spots 9, adjusting parameters of the multimode laser scanning mirror 6 so as to let the width W₁ of the spot be 1 mm-2 mm, and ensuring that the relationship between the length L₁ and the width W of the spot is L₁=W+4 mm; and for the arc line-shape bending of the sector sheet 10, installing a single piezoelectric deformable mirror 11 under the laser head 4 of a laser so as to convert laser Gaussian distributed point spots 5 emitted by the laser head 4 of the laser to uniformly distributed arc line-shape spots 14, and adjusting the width W₂ of the spot to 1 mm-2 mm, wherein the relationship between the arc length L₂ of the arc bending line 13 and the length L₃ of the arc line-shape spot 14 is L₃=L₂+4 mm;

Step 3: workpiece installation and laser adjusting: clamping one end of the metal sheet in the longitudinal direction by using a clamping plate 1, freely suspending the other end, and fixing the metal sheet on a laser processing workbench; according to the processing technical requirements, the position of the bending line is selected based on the free end, the distance between the straight bending line 8 of the rectangular sheet 2 and the free end is D, and the sector sheet 10 has the arc bending line 13 concentric with the outer circle of the sheet, has the radius of R₁, and has a distance of R-R₁ from the free end; moving the laser head 4 of the laser by using machine tool linkage to the midpoint position above the bending line, adjusting the angle of the multimode laser scanning mirror 6 or the single piezoelectric deformable mirror 11 to make the line-shape spot 9 coincide with the straight bending line 8 or make the arc line-shape spot 14 coincide with the arc bending line 13, and ensuring that both sides of the bending line in the length direction have a 2-mm laser loading margin respectively; and setting the operating parameters of the laser head 4 of the laser: the laser power is 100 W-180 W, the laser pulse width is 1 ms-3 ms, the pulse frequency is 30 Hz-50 Hz, and the scanning speed is 400 mm/min-800 mm/min;

Step 4: auxiliary blowing adjusting: adjusting the position of an auxiliary blowing nozzle 3 to prevent the workpiece from hitting the blowing head during processing; using inert gas as the gas for auxiliary blowing to prevent high-temperature oxidation; and adjusting the air pressure to 0.1 MPa-0.5 MPa to ensure stable blowing during processing;

Step 5: laser loading: starting the laser to load the laser at the bending line, and maintaining the loading time to T once according to the required bending angle; and cooling to below 100° C. after each loading, repeating loading for many times and cooling to complete bending of the metal sheet.

The rectangular sheet 2 has the length L of 40 mm-120 mm and the width W of 30 mm-100 mm; the sector sheet 10 has the exradius R of 50 mm-200 mm and the central angle n of 30°-60°; and the sheet thickness is 1 mm-2 mm

The present invention has the following beneficial effect: on the basis of theoretical analysis and finite element simulation, in view of problems of heat accumulation and heat dissipation through boundary of the temperature field during laser mobile scanning bending, the present invention adopts a laser bending method for simultaneous heating through line-shape spots in the bending line of the metal sheet, and proposes a simple, high-efficiency, low-cost and low-warpage bending method, which has the outstanding characteristics of large laser bending angle, small warpage and short bending man-hour in laser forming under the same laser process parameters.

### DESCRIPTION OF DRAWINGS

FIG. 1 is a schematic diagram of line-shape spot laser bending of a rectangular sheet;

FIG. 2 is a schematic diagram of concentric arc line-shape spot laser bending of a sector sheet.

FIG. 3 is a cloud chart of a numerical simulation displacement field of laser bending for simultaneous heating through line-shape spots of a rectangular sheet.

FIG. 4 is a cloud chart of a numerical simulation displacement field of laser bending for linear scanning of a point spot moving heat source of a rectangular sheet.

In the figures: 1 clamping plate; 2 rectangular sheet; 3 auxiliary blowing nozzle; 4 laser head of laser; 5 point spot; 6 multimode laser scanning mirror; 7 rectangular sheet bending angle; 8 straight bending line; 9 line-shape spot; 10 sector sheet; 11 single piezoelectric deformable mirror; 12 sector sheet bending angle; 13 arc bending line; and 14 arc line-shape spot.

### DETAILED DESCRIPTION

Specific embodiments of the present invention are further described below in combination with accompanying drawings and the technical solution.

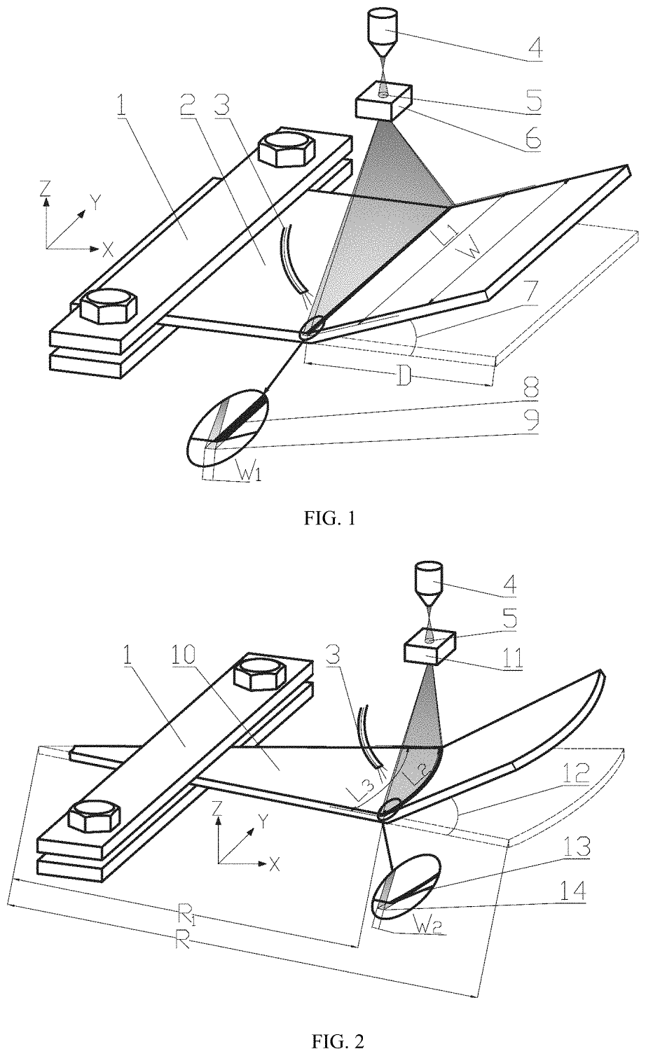

In the line-shape spot laser bending method for metal sheets of the present invention, the principles of laser bending of line-shape spots of the rectangular sheet and concentric arc line-shape spots of the sector sheet are shown in FIG. 1 and FIG. 2 respectively.

The specific steps are as follows:

Step 1: workpiece preparation: according to the dimension and technical requirements, processing metal sheets with the required specifications, wherein the sheet thickness is 1 mm-2 mm; the rectangular sheet 2 has the length L of 40 mm-120 mm and the width W of 30 mm-100 mm; the sector sheet 10 has the exradius R of 50 mm-200 mm and the central angle n of 30°-60°; and the sheet thickness is 1 mm-2 mm.

Step 2: line-shape spot setting: for the linear bending of the rectangular sheet 2, installing a multimode laser scanning mirror 6 under the laser head 4 of a laser so as to convert laser Gaussian distributed point spots 5 emitted by the laser head 4 of the laser to uniformly distributed line-shape spots 9, adjusting parameters of the multimode laser scanning mirror 6 so as to let the width W₁ of the spot be 1 mm-2 mm, and ensuring that the relationship between the length L₁ and the width W of the spot is L₁=W+4 mm; and for the arc line-shape bending of the sector sheet 10, installing a single piezoelectric deformable mirror 11 under the laser head 4 of a laser so as to convert laser Gaussian distributed point spots 5 emitted by the laser head 4 of the laser to uniformly distributed arc line-shape spots 14, and adjusting the width W₂ of the spot to 1 mm-2 mm, wherein the relationship between the arc length L₂ of the arc bending line 13 and the length L₃ of the arc line-shape spot 14 is L₃=L₂+4 mm;

Step 3: workpiece installation and laser adjusting: clamping one end of the metal sheet in the longitudinal direction by using a clamping plate 1, freely suspending the other end, and fixing the metal sheet on a laser processing workbench; according to the processing technical requirements, the position of the bending line is selected based on the free end, the distance between the straight bending line 8 of the rectangular sheet 2 and the free end is D, and the sector sheet 10 has the arc bending line 13 concentric with the outer circle of the sheet, has the radius of R₁, and has a distance of R-R₁ from the free end; moving the laser head 4 of the laser by using machine tool linkage to the midpoint position above the bending line, adjusting the angle of the multimode laser scanning mirror 6 or the single piezoelectric deformable mirror 11 to make the line-shape spot 9 coincide with the straight bending line 8 or make the arc line-shape spot 14 coincide with the arc bending line 13, and ensuring that both sides of the bending line in the length direction have a 2-mm laser loading margin respectively; and setting the operating parameters of the laser head 4 of the laser: the laser power is 100 W-180 W, the laser pulse width is 1 ms-3 ms, the pulse frequency is 30 Hz-50 Hz, and the scanning speed is 400 mm/min-800 mm/min;

Step 4: auxiliary blowing adjusting: adjusting the position of an auxiliary blowing nozzle 3 to prevent the workpiece from hitting the blowing head during processing; using inert gas as the gas for auxiliary blowing to prevent high-temperature oxidation; and adjusting the air pressure to 0.1 MPa-0.5 MPa to ensure stable blowing during processing;

Step 5: laser loading: starting the laser to load the laser at the bending line, and maintaining the loading time to T once according to the required bending angle, wherein T is determined by the rectangular sheet bending angle 7 or the sector sheet bending angle 12; and cooling to below 100° C. after each loading, repeating loading for many times and cooling to complete bending of the metal sheet.

In the embodiment, the ANSYS software is used to perform three-dimensional finite element simulation on the laser linear bending process of the line-shape spots of the rectangular sheet, and the analysis and comparison in three aspects of forming accuracy, bending efficiency and bending performance are given in combination with the linear scanning laser bending process of the Gauss distributed point spot moving heat source.

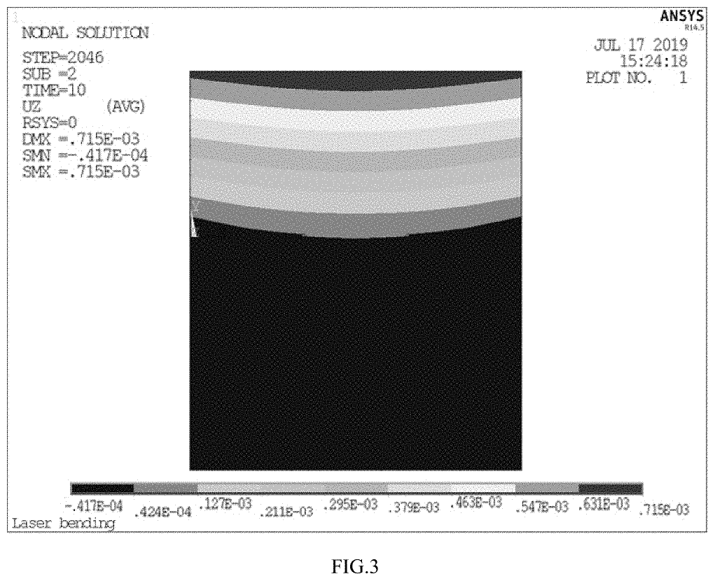

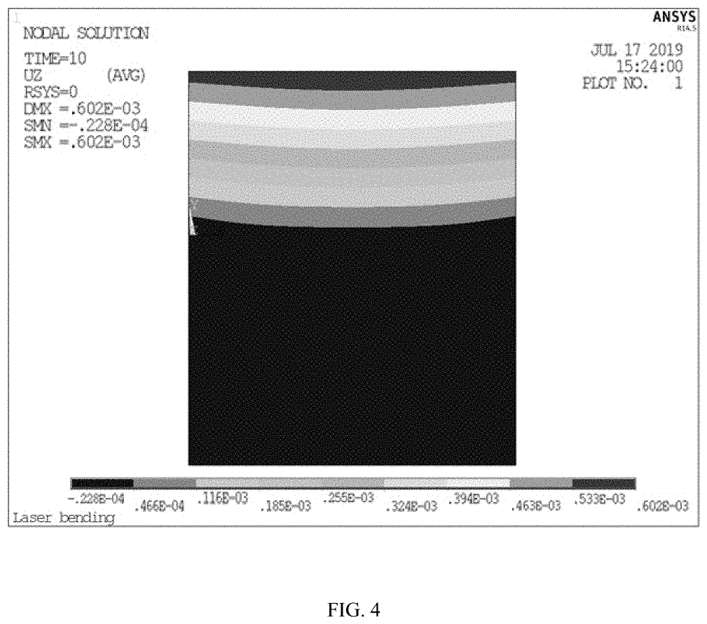

For the linear scanning laser bending process of the Gauss distributed point spot moving heat source, the rectangular sheet is modeled to have the length of 60 mm and the width of 50 mm, and a constraint load is applied to one end in the length direction to simulate the clamping and fixing of the clamping plate. In the three-dimensional finite element simulation of linear scanning bending of the Gauss distributed point spot moving heat source, the diameter of the point spot is 1.8 mm, the laser power is 140 W, the laser pulse width is 2 ms, the pulse frequency is 40 Hz, the scanning speed is 400 mm/min, the position of the bending line is 25 mm from the free end, and the cloud chart of the displacement field of the simulated result is shown in FIG. 3. In order to compare the linear scanning bending of the Gaussian distributed point spot moving heat source, in the three-dimensional finite element simulation of bending of simultaneous heating through line-shape spots of the present invention, it is necessary to ensure the equivalent energy input of simultaneous heating through line-shape spots and mobile scanning heating through point spots. Therefore, according to the calculation, a line-shape spot with the width of 1.13 mm, the length of 54 mm and the heat flux of 0.19×10⁹ W/m² is applied to the bending line. The laser pulse width, the pulse frequency and the position of the bending line remain unchanged, the loading time is one cycle 0.025 s of the point source laser pulse, and the cloud chart of the displacement field of the simulated result is shown in FIG. 4.

According to FIG. 3 and FIG. 4, the distribution cloud chart of the Z-direction displacement field after loading is compared and analyzed, and the bending angle and warpage deformation generated are calculated. The analysis shows that:

(1) Under the same laser process parameters, the bending angles after simultaneous heating through line-shape spots and one-time mobile scanning loading through point spot pulse laser are respectively 1.64° and 1.38°, and the bending angle of simultaneous heating through line-shape spots is increased by 18.84% compared with that of mobile scanning through point spots, which obviously increases the bending angle of the sheet;

(2) Based on calculation, the chord heights of warpage deformation are respectively 0.115 mm and 0.217 mm, and the warpage deformation of simultaneous heating through line-shape spots is reduced by 47% compared with that of mobile scanning through point spots, which significantly reduces the bending warpage of the sheet;

(3) According to the calculation of the sheet width and scanning speed, the time of one-time mobile scanning through point spot pulse laser is 7.5 s, and the time for integrally cooling the sheet to 100° C. is about 5 s-8 s; one-time simultaneous heating through line-shape laser spots is about 0.025 s, and the time for integrally cooling the sheet to 100° C. is about 8 s. As obtained from the calculation, under the condition of one-time heating, simultaneous heating through line-shape spots can save man-hour by about 35.8%-48.23% compared with mobile scanning through point spots, which significantly shortens the bending man-hour of the sheet.

The line-shape spot described in the technical solution of the present invention can be obtained by an experimental device:

The line-shape spot 9 can be obtained by the multimode laser scanning mirror 6, and the principle of the multimode laser scanning mirror 6 is to use a polyhedral prism as a scanning element, make the beam swing quickly by prismatic reflection and broaden the beam into a line-shape spot;

For the arc line-shape spot 14, a circular line-shape spot can be obtained first by the single piezoelectric deformable mirror 11, and then an arc line-shape spot with the required length is cut for use. The principle of the single piezoelectric deformable mirror 11 is to first iterate the required wavefront phase in combination with the light wave diffraction theory and the related algorithm to use the beam wavefront information as feedback to control the wavefront phase required for reconstruction of a deformable mirror to obtain an arc line-shape spot with controllable diameter and width.

1. A line-shape spot laser bending method for metal sheets, wherein the method comprises the following specific steps:
step 1: workpiece preparation: according to the dimension and technical requirements, processing metal sheets with the required specifications, including a rectangular sheet (2) and a sector sheet (10), wherein the width of the rectangular sheet (2) is W, and the exradius of the sector sheet (10) is R;
step 2: line-shape spot setting: for the linear bending of the rectangular sheet (2), installing a multimode laser scanning mirror (6) under the laser head (4) of a laser so as to convert laser Gaussian distributed point spots (5) emitted by the laser head (4) of the laser to uniformly distributed line-shape spot (9), adjusting parameters of the multimode laser scanning mirror (6) so as to let the width W₁ of the spot be 1 mm-2 mm, and ensuring that the relationship between the length L₁ and the width W of the spot is L₁=W+4 mm; and for the arc line-shape bending of the sector sheet (10), installing a single piezoelectric deformable mirror (11) under the laser head (4) of a laser so as to convert laser Gaussian distributed point spots (5) emitted by the laser head (4) of the laser to uniformly distributed arc line-shape spots (14), and adjusting the width W₂ of the spot to 1 mm-2 mm, wherein the relationship between the arc length L₂ of the arc bending line (13) and the length L₃ of the arc line-shape spot (14) is L₃=L₂+4 mm;
step 3: workpiece installation and laser adjusting: clamping one end of the metal sheet in the longitudinal direction by using a clamping plate (1), freely suspending the other end, and fixing the metal sheet on a laser processing workbench; according to the processing technical requirements, the position of the bending line is selected based on the free end, the distance between the straight bending line (8) of the rectangular sheet (2) and the free end is D, and the sector sheet (10) has the arc bending line (13) concentric with the outer circle of the sheet, has the radius of R₁, and has a distance of R-R₁ from the free end; moving the laser head (4) of the laser by using machine tool linkage to the midpoint position above the bending line, adjusting the angle of the multimode laser scanning mirror (6) or the single piezoelectric deformable mirror (11) to make the line-shape spot (9) coincide with the straight bending line (8) or make the arc line-shape spot (14) coincide with the arc bending line (13), and ensuring that both sides of the bending line in the length direction have a 2-mm laser loading margin respectively; and setting the operating parameters of the laser head (4) of the laser: the laser power is 100 W-180 W, the laser pulse width is 1 ms-3 ms, the pulse frequency is 30 Hz-50 Hz, and the scanning speed is 400 mm/min-800 mm/min;
step 4: auxiliary blowing adjusting: adjusting the position of an auxiliary blowing nozzle (3) to prevent the workpiece from hitting the blowing head during processing; using inert gas as the gas for auxiliary blowing to prevent high-temperature oxidation; and adjusting the air pressure to 0.1 MPa-0.5 MPa to ensure stable blowing during processing;
step 5: laser loading: starting the laser to input the laser energy at the bending line, and maintaining the loading time to T once according to the required bending angle; and cooling to below 100° C. after each loading, repeating loading for many times and cooling to complete bending of the metal sheet.

2. The line-shape spot laser bending method for metal sheets according to claim 1, wherein the rectangular sheet (2) has the length L of 40 mm-120 mm and the width W of 30 mm-100 mm; the sector sheet (10) has the exradius R of 50 mm-200 mm and the central angle n of 30°-60°; and the sheet thickness is 1 mm-2 mm.
